(19) United States
(12) Patent Application Publication
(10) Pub. No.: US 2009/0066684 A1
(43) Pub. Date: Mar. 12, 2009

(54) DISPLAY AND DISCHARGING DEVICE OF THE SAME

(75) Inventor: Kyung-Hun LEE, Masan-Si (KR)

Correspondence Address: CANTOR COLBURN, LLP, 20 Church Street, 22nd Floor, Hartford, CT, 06103, US

(73) Assignee: Samsung Electronics Co., Ltd, Suwon-si (KR)

(21) Appl. No.: 12/204,023

(22) Filed: Sep. 4, 2008

(30) Foreign Application Priority Data
Sep. 10, 2007 (KR) 10-2007-0091656

(51) Int. Cl. G09G 5/00

(52) U.S. Cl. 345/211

(57) ABSTRACT

A display including a display panel having a plurality of gate lines connected to a plurality of pixels, a gate driving unit which sequentially provides a gate turn-on voltage to the plurality of gate lines and provides a control voltage to the plurality of gate lines to which the gate turn-on voltage is not applied, and a discharging unit including a first input terminal receiving the gate turn-on voltage, a second input terminal receiving a first gate turn-off voltage, a output terminal outputting the control voltage and a short-circuit protection unit which prevents short-circuiting between the first input terminal and the second input terminal. The discharging unit provides the control voltage to the gate driving unit and a voltage level of the control voltage changes to any one level of a gate turn-on voltage and a first gate turn-off voltage response to a supply voltage.

This application claims priority to Korean Patent Application No. 10-2007-0091656 filed on Sep. 10, 2007 and all of the benefits accruing there from under 35 U.S.C. 119, the contents of which in its entirety are herein incorporated by reference.

### BACKGROUND OF THE INVENTION

1. Field of the Invention

The present invention relates to a display and a discharging device of the same, and more particularly, to a display and a discharging device of the same which is capable of preventing overcurrent in a display panel of the display, when a turn-on voltage is applied thereto.

2. Description of the Related Art

In a liquid crystal display (“LCD”), data signals are provided to pixel electrodes of liquid crystal capacitors in a liquid crystal (“LC”) panel using external control signals to thereby change an electric field across the LC capacitor and control the alignment of liquid crystal in the LC capacitor, thereby adjusting an amount of light transmitted through the liquid crystal to display an image.

When the LCD is turned off by a user, the LC panel is not completely turned off and displays an abnormal picture such as image sticking. When the LCD is turned off, charges (i.e., data signals) are naturally discharged from the liquid crystal capacitors in the liquid crystal panel. However, it takes some time for all the charges to be completely discharged from the LC capacitors, during which the LC panel displays an abnormal picture.

In a conventional LCD, a circuit for forcibly discharging charges from the LC capacitors when the LCD is turned off is used to prevent an abnormal picture such as image sticking from being displayed. However, the use of the circuit for forcibly discharging charges from the LC capacitor causes overcurrent in the liquid crystal panel when the LCD is turned on.

### BRIEF SUMMARY OF THE INVENTION

The present invention has made an effort to solve the above-stated problems and aspects of the present invention provide a display and a discharging device of the same, capable of preventing overcurrent in a display panel of the display by means of a discharging unit for discharging accumulated charges from the display panel.

According to an exemplary embodiment, the present invention provides a display including a display panel having a plurality of gate lines connected to a plurality of pixels, a gate driving unit which sequentially provides a gate turn-on voltage to the plurality of gate lines and provides a control voltage to the plurality of gate lines to which the gate turn-on voltage is not applied, and a discharging unit including a first input terminal receiving the gate turn-on voltage, a second input terminal receiving a first gate turn-off voltage, a output terminal outputting the control voltage and a short-circuit protection unit which prevents short-circuiting between the first input terminal and the second input terminal. The discharging unit provides the control voltage to the gate driving unit and a voltage level of the control voltage changes to any one level of a gate turn-on voltage and a first gate turn-off voltage response to a supply voltage.

According to an exemplary embodiment, the discharging unit outputs the first gate turn-off voltage as the control voltage while the supply voltage is applied to the display and uses the gate turn-on voltage at a point when the supply voltage is not applied to the display.

According to an exemplary embodiment, the discharging unit further includes a first switching unit which outputs the first gate turn-off voltage as the control voltage while the supply voltage is applied to the display, a charge storage unit which stores the gate turn-on voltage, and a second switching unit which outputs the stored gate turn-on voltage as the control voltage at a point when the supply voltage is not applied.

According to an exemplary embodiment, the short-circuit protection unit is connected to the first input terminal and provides the gate turn-on voltage to the charge storage unit.

According to an exemplary embodiment, the first switching unit includes a first transistor having an emitter connected to the second input terminal and a collector connected to an output terminal, a first resistor connected to a base of the first transistor and a ground, and a second resistor connected to the collector of the first transistor and ground.

According to an exemplary embodiment, the short-circuit protection unit includes a third resistor connected to the first input terminal and an output terminal.

According to an exemplary embodiment, the charge storage unit includes a first diode connected to the output terminal and an input terminal of the second switching unit, a fourth resistor connected to the output terminal and a ground, first and second capacitors connected in series between the input terminal of the second switching unit and the ground, a fifth resistor connected in parallel with the second capacitor, third and fourth capacitors connected in series between the input terminal of the second switching unit and the ground, and a sixth resistor connected in parallel with the fourth capacitor, and the second switching unit includes a second transistor having an emitter connected to the input terminal of the second switching unit and a collector connected to an output terminal, and a seventh resistor connected to a base of the second transistor and the output terminal of the short-circuit protection unit.

According to an exemplary embodiment, the short-circuit protection unit includes a switching device which turns on and off depending on an amount of current flowing at the gate turn-on voltage.

According to an exemplary embodiment, each of the plurality of pixels includes a thin film transistor (TFT), the gate turn-on voltage turns on the TFT, and the first gate turn-off voltage turns off the TFT.

According to an exemplary embodiment, the display further includes a driving-voltage generating unit which generates the gate turn-on voltage, the first gate turn-off voltage and a second gate turn-off voltage according to the supply voltage, and a gate clock generating unit which generates a gate clock signal, a gate clock bar signal and a second vertical synchronization start signal using the gate turn-on voltage, the second gate turn-off voltage and a first vertical synchronization start signal, wherein the gate driving unit includes a plurality of stages respectively connected to the plurality of gate lines, and the plurality of stages sequentially provide the gate turn-on signal to the plurality of gate lines according to the gate clock signal, the gate clock bar signal and the second vertical synchronization start signal.

According to an exemplary embodiment, the gate driving unit is formed at one side of the display panel. Alternatively, according to another exemplary embodiment, the gate driving unit is manufactured in the form of an integrated circuit (“IC”) chip to be connected to the plurality of gate lines of the display panel.

According to an exemplary embodiment, the discharging unit is provided on a printed circuit board (“PCB”) electrically connected to the display panel via a flexible printed circuit board (“FPCB”) or on the FPCB.

According to another exemplary embodiment, the present invention provides a discharging device of a display which supplies a gate turn-off voltage to a display panel of the display while a supply voltage is applied and which supplies a gate turn-on voltage to the display panel at a point when the supply voltage is not applied. The discharging device includes a short-circuit protection unit which prevents short-circuiting between an input terminal of the gate turn-on voltage and an input terminal of a first gate turn-off voltage.

According to an exemplary embodiment, the discharging device further includes a first switching unit which supplies the gate turn-off voltage to the display panel while the supply voltage is being applied to the display, a charge storage unit which stores the gate turn-on voltage, and a second switching unit which supplies the stored gate turn-on voltage to the display panel at the point when the supply voltage is not applied to the display.

According to an exemplary embodiment, the short-circuit protection unit is connected to the input terminal of the gate turn-on voltage and provides the gate turn-on voltage to the charge storage unit.

According to an exemplary embodiment, the short-circuit protection unit includes a resistor.

According to another exemplary embodiment, the short-circuit protection unit includes a switching device which is turned on and off depending on an amount of current flowing at the gate turn-on voltage.

### BRIEF DESCRIPTION OF THE DRAWINGS

The above and other aspects, features and advantages of the present invention will become apparent from the following description of preferred embodiments given in conjunction with the accompanying drawings, in which:

FIG. 1 is a block diagram of an exemplary embodiment of a display according to the present invention;

FIG. 2 is a block diagram of an exemplary embodiment of a gate driving unit according to the present invention;

FIG. 3 is a block diagram of an exemplary embodiment of a driving-voltage generating unit according to the present invention;

FIG. 4 is a block diagram of another exemplary embodiment of a driving-voltage generating unit according to the present invention;

FIG. 5 is a block diagram of an exemplary embodiment of a discharging unit according to the present invention; and

FIGS. 6 and 7 are circuit diagrams of the discharging unit of FIG. 5.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

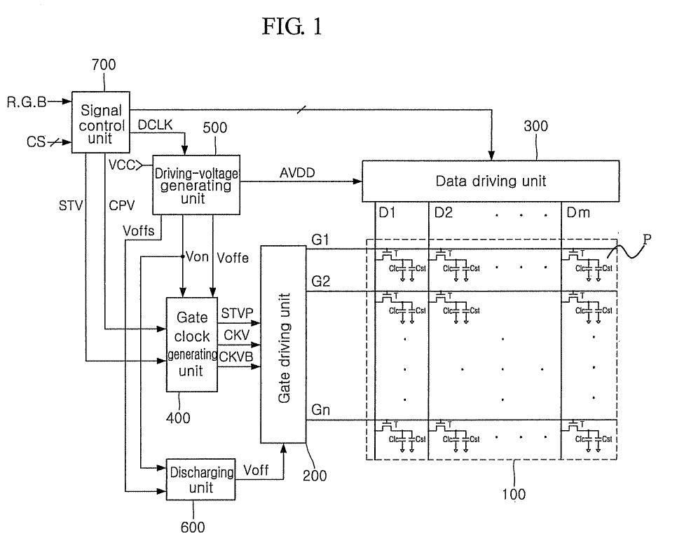

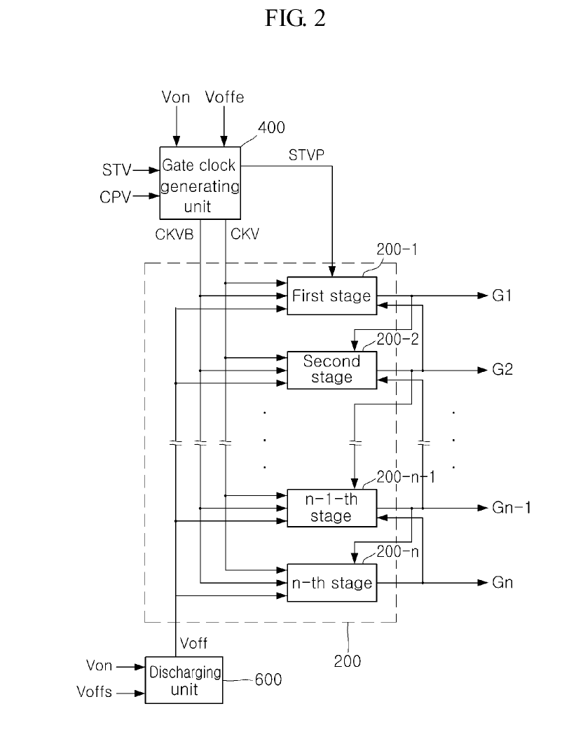

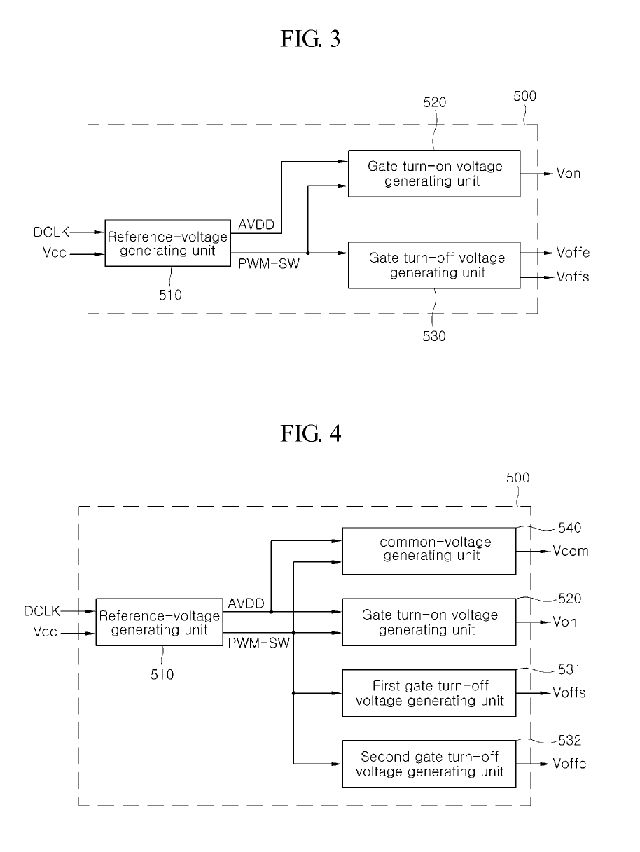

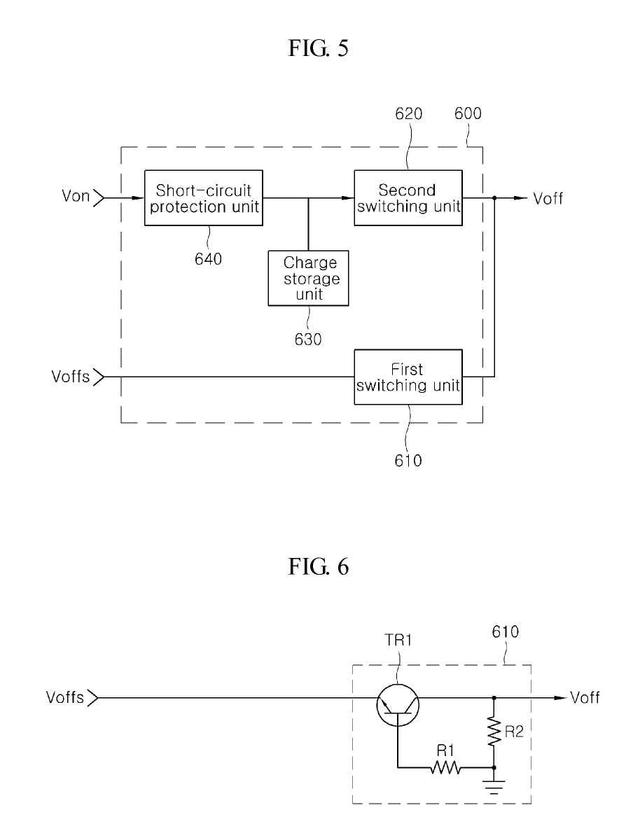

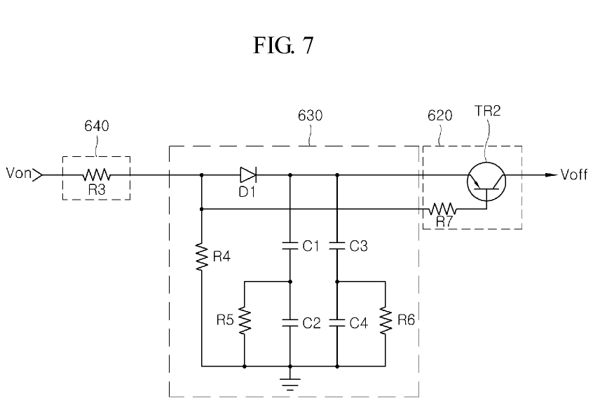

FIG. 1 is a block diagram of an exemplary embodiment of a display according to the present invention. FIG. 2 is a block diagram of an exemplary embodiment of a gate driving unit according to the present invention. FIG. 3 is a block diagram of an exemplary embodiment of a driving-voltage generating unit according to the present invention, and FIG. 4 is a block diagram of another exemplary embodiment of a driving-voltage generating unit according to the present invention. FIG. 5 is a block diagram of an exemplary embodiment of a discharging unit according to the present invention, and FIGS. 6 and 7 are circuit diagrams of the discharging unit.

Referring to FIGS. 1-7, the display according to this exemplary embodiment includes a display panel 100, a gate driving unit 200, a data driving unit 300, a gate clock generating unit 400, a driving-voltage generating unit 500, a discharging unit 600 and a signal control unit 700.

The display panel 100 includes a plurality of gate lines G1 to Gn extending in a first direction, and a plurality of data lines D1 to Dm extending in a second direction intersecting the gate lines G1 to Gn. The display panel 100 further includes a plurality of pixels P connected to the gate lines G1 to Gn and the data lines D1 to Dm. The plurality of pixels P are arranged in a matrix form in a display area of the display panel 100. Each pixel P includes a thin film transistor T and a liquid crystal capacitor Clc. According to an exemplary embodiment, the pixel P further includes a storage capacitor Cst. In addition, the plurality of pixels P display red R, green G and blue B colors, respectively.

According to an exemplary embodiment, the display panel 100 includes upper and lower transparent substrates (not shown). The thin film transistors T, the gate lines G1 to Gn, the data lines D1 to Dm, pixel electrodes for the liquid crystal capacitors Clc, and storage electrodes for the storage capacitors Cst are provided on the lower substrate of the display panel 100. A light shielding pattern (e.g., a black matrix), color filters, and a common electrode for the liquid crystal capacitors Clc are provided on the upper substrate. A liquid crystal layer is provided between the upper substrate and the lower substrate.

The thin film transistors T include gate terminals connected to the gate lines G1 to Gn, source terminals connected to the data lines D1 to Dm, and drain terminals connected to the pixel electrodes. The thin film transistor T operates according to a gate turn-on signal applied to the gate line, and supplies a data signal (i.e., a gradation signal) from a corresponding data lines D1 to Dm to the pixel electrode to thereby change an electric field across the liquid crystal capacitor Clc. Accordingly, arrangement of the liquid crystal in the display panel 100 is changed and the transmission of light supplied from a backlight can be adjusted.

According to an exemplary embodiment, the pixel electrode includes a number of grooves and/or bump patterns as a domain control means for adjusting an arrangement direction of the liquid crystal. The common electrode includes a number of bumps and/or groove patterns. In this exemplary embodiment, the liquid crystal may be aligned in a vertical alignment mode.

A controller including the gate driving unit 200, the data driving unit 300, the gate clock generating unit 400, the driving-voltage generating unit 500, the discharging unit 600 and a signal control unit 700 is provided outside the display panel 100 having the aforementioned structure. The controller supplies driving signals to the display panel 100, so that the display panel 100 displays an image using light from an external light source (e.g., a backlight). According to an exemplary embodiment, the gate driving unit 200, the data driving unit 300, the gate clock generating unit 400, the driving-voltage generating unit 500, the discharging unit 600 and a signal control unit 700 are manufactured in the form of an IC chip and electrically connected to the display panel 100. Each of the gate driving unit 200, the data driving unit 300, the gate clock generating unit 400, the driving-voltage generating unit 500, the discharging unit 600 and a signal control unit 700 may be manufactured in the form of separate chips, or some of them may be integrated into a single chip. The chip(s) may be directly mounted on the display panel 100 or on an additional printed circuit board. Alternatively, according to another exemplary embodiment, the chip(s) may be mounted on a FPCB for connecting the display panel 100 and the PCB. According to yet another exemplary embodiment, some of the gate driving unit 200, the data driving unit 300, the gate clock generating unit 400, the driving-voltage generating unit 500, the discharging unit 600 and a signal control unit 700 are manufactured together with the display panel 100. In this exemplary embodiment, the gate driving unit 200 is integrated into the lower substrate of the display panel 100. That is, the gate driving unit 200 is manufactured together with the thin film transistors T of the display panel 100. The units of the controller will now be described.

As shown in FIG. 1, the signal control unit 700 receives image signals R, G and B and an image control signal CS which controls the display of the image signals R, G and B from an external graphic controller (not shown). The image signals R, G and B include original pixel data (i.e., red, green and blue data). The image control signal CS includes a vertical synchronization signal Vsync, a horizontal synchronization signal Hsync, a main clock CLK, and a data enable signal DE. The signal control unit 700 processes the image signals R, G and B according to an operational condition of the display panel 100.

The signal control unit 700 generates a plurality of control signals including a gate control signal and a data control signal. The signal control unit 700 sends the gate control signal to the gate clock generating unit 400 and the data control signal to the data driving unit 300. The gate control signal includes a first vertical synchronization start signal STV and a driving clock signal CPV. The data control signal includes a horizontal synchronization start signal STH which indicates transmission start of a pixel data signal, a load signal LOAD which instructs to apply a data voltage to the corresponding data line, and a data clock signal DATA. According to an exemplary embodiment, the data control signal further includes an inversion signal INV which inverts the polarity of a gradation voltage with respect to a common voltage.

According to an exemplary embodiment, the driving-voltage generating unit 500 generates various driving voltages required for driving the display using the external supply voltage Vcc and the driving voltage clock DCLK. The driving-voltage generating unit 500 generates a reference voltage AVDD, a gate turn-on voltage Von, and the common voltage. The driving-voltage generating unit 500 also generates a first gate turn-off voltage Voffs to be used as a control voltage Voff which turns off the thin film transistors T of the display panel 100. The driving-voltage generating unit 500 also generates a second gate turn-off voltage Voffe.

The driving-voltage generating unit 500 applies the gate turn-on voltage Von and the second gate turn-off voltage Voffe to the gate clock signal generating unit 400, and applies the reference voltage AVDD to the data driving unit 300. The driving-voltage generating unit 500 provides the first gate turn-off voltage Voffs to the discharging unit 600. According to an exemplary embodiment, the driving-voltage generating unit 500 directly supplies the first gate turn-off voltage Voffs to the gate driving unit 200 as the control voltage Voff and supplies the gate turn-on voltage Von to the discharging unit 600. According to an exemplary embodiment, the gate turn-on voltage Von is in a range of approximately 15 to 30 volts, the first gate turn-off voltage Voffs is in a range of approximately −15 to −3 volts, and the second gate turn-off voltage Voffe is in a range of approximately −20 to −7 volts. Generally, the first gate turn-off voltage Voffs is equal to the second gate turn-off voltage Voffe or more.

The discharging unit 600 receives the gate turn-on voltage Von and the first gate turn-off voltage Voffs, and outputs one of the gate turn-on voltage Von and the first gate turn-off voltage Voffs, as the control voltage Voff, according to a state of the external supply voltage Vcc. That is, when the external supply voltage Vcc is applied, the discharging unit 600 outputs the first gate turn-off voltage Voffs as the control voltage Voff. When the external supply voltage Vcc is not applied, the discharging unit 600 outputs the gate turn-on voltage Von as the control voltage Voff.

The voltages supplied to the discharging unit 600 are not limited thereto but voltages of various levels may be supplied to the discharging unit 600. For example, a voltage level capable of turning on the thin film transistors T of the display panel 100 may be supplied instead of the gate turn-on voltage Von. Also, a voltage level capable of turning off the thin film transistors T of the display panel 100 may be supplied instead of the first gate turn-off voltage Voffs. Here, a state where the external supply voltage Vcc is applied refers to a state where the display is turned on, and a state where the external supply voltage Vcc is not applied refers to a state at a point when the display is turned off. Here, the point when the display is turned off refers to a point when the gate turn-on voltage Von becomes 0V.

As such, the discharging unit 600 instantaneously increases the control voltage Voff provided to the gate driving unit 200 up to the gate turn-on voltage Von at the point when the display is turned off. Accordingly, a signal corresponding to the gate turn-on voltage Von is applied to all the gate lines G1 to Gn connected to the gate driving unit 200, so that all the thin film transistors T in the display panel 100 are turned on. In this way, the charges in the liquid crystal capacitors Clc of the display panel 100 can be rapidly discharged.

The discharging unit 600 further includes a short-circuit protection unit 640 for preventing short-circuit between an input terminal of the gate turn-on voltage and an input terminal of the first gate turn-off voltage at a point of time when the external supply voltage is applied. This will be described in detail later. Here, the point when the external supply voltage Vcc is applied refers to a point when the display is turned on by a user. The point when the display is turned on refers to a point when the external supply voltage Vcc is applied to the display, and the gate turn-on voltage Von rises to a normal level (e.g., 15V to 30V).

According to an exemplary embodiment, the discharging unit 600 is manufactured in a form of a chip and mounted on a PCB or a FPCB. Circuit elements of the discharging unit 600 may be located on the printed circuit board or the flexible printed circuit board.

The data driving unit 300 generates the gradation signal using the data control signal the pixel data signal from the signal control unit 700 and the reference voltage AVDD from the driving-voltage generating unit 500, and then applies the gradation signal to the respective data lines D1 to Dm. That is, the data driving unit 300 is driven according to the data control signal and converts the input digital pixel data signal into the analog gradation signal using the reference voltage AVDD. In addition, the data driving unit 300 supplies the converted gradation data signal to the plurality of data lines D1 to Dm.

The gate clock generating unit 400 generates the second vertical synchronization start signal STVP, the gate clock signal CKV and the gate clock bar signal CKVB according to the first vertical synchronization start signal STV and the driving clock signal CPV from the signal control unit 700 and the gate turn-on voltage Von and the second gate turn-off voltage Voffe from the driving-voltage generating unit 500. The gate clock bar signal CKVB is an inverted signal of the gate clock signal CKV. The gate clock generating unit 400 provides the second vertical synchronization start signal STVP, the gate clock signal CKV and the gate clock bar signal CKVB to the gate driving unit 200. According to an exemplary embodiment, a voltage level in a logic high section of the gate clock signal CKV and the gate clock bar signal CKVB is the same as the voltage level of the gate turn-on voltage Von. Pulse widths of the logic high and logic low sections and a signal period of the gate clock signal CKV and the gate clock bar signal CKVB may vary according to the driving clock signal CPV. The second vertical synchronization start signal STVP includes a similar waveform to the first vertical synchronization start signal STV. Further, a maximum voltage level of the second vertical synchronization start signal STVP is the same as the gate turn-on voltage Von. That is, the second vertical synchronization start signal STVP includes a similar pulse width to the first vertical synchronization start signal STV, and amplitude of the second vertical synchronization start signal STVP is the same as difference of the gate turn-on voltage Von and the second gate turn-off voltage Voffe.

According to an exemplary embodiment, the gate driving unit 200 applies the gate turn-on signal and the gate turn-off signal to the plurality of gate lines G1 to Gn according to the second vertical synchronization start signal STVP, the gate clock signal CKV and the gate clock bar signal CKVB and the control voltage Voff.

According to an exemplary embodiment, the gate driving unit 200 is integrated into the display panel 100. The gate driving unit 200 is not limited thereto but may be manufactured in the form of a chip and mounted on the display panel 100, the PCB or the FPCB. The gate driving unit 200 is connected to the gate lines G1 to Gn of the display panel 100. The aforementioned printed circuit board refers to a board having the units of the controller, i.e., the signal control unit, the driving-voltage generating unit, the data driving unit and the like that are mounted thereon and electrically connected to the display panel 100.

According to an exemplary embodiment, the level of the control voltage Voff is changed by the discharging unit 600 at the point when the display is turned off.

First, the operation of gate driving unit 200 when the display is normally driven (i.e., when the external supply voltage Vcc is applied and the display is turned on) will now be described.

The gate turn-on signal is sequentially provided to the plurality of gate lines G1 to Gn in order to turn on the thin film transistors T of the display panel 100. The gate turn-on signal is a single-pulse signal. The gate turn-on signal may be supplied to the corresponding gate lines G1 to Gn during one horizontal clock period (1H). The gate turn-on signal is provided to the gate lines G1 to Gn during a logic high section of the gate clock signal CKV or the gate clock bar signal CKVB. Accordingly, the thin film transistors T connected to the respective gate lines G1 to Gn are turned on and an image is displayed. During a section where the gate turn-on signal is not applied, the gate turn-off signal is applied. That is, to look into one gate line during one frame, the gate turn-on signal is applied to the gate line only during one horizontal clock period (1H) and the gate turn-off signal is applied to the gate line during the rest of the section. According to an exemplary embodiment, the gate turn-on signal includes a same voltage level as the gate turn-on voltage Von and the gate turn-off signal includes the same voltage level as the control voltage Voff.

On the contrary, at the point when the display is turned off, the level of the gate turn-on signal is gradually lowered because the driving-voltage generating unit 500 and the gate clock generating unit 400 no longer operate. Accordingly, the gate turn-on signal is no longer applied to the gate lines. The gate turn-off signal is applied to the gate lines G1 to Gn. Thus, the gate turn-off signal is changed by discharging unit 600 from a level of the first gate turn-off voltage Voffs to a level of the gate turn-on voltage Von. Accordingly, the gate turn-off signal having the gate turn-on voltage level is instantaneously provided to all the gate lines G1 to Gn, whereby the thin film transistors T connected to the gate lines G1 to Gn are turned on. In this way, at the point when the display is turned off, the charges can be discharged from the liquid crystal capacitors Clc by the turned-on thin film transistors T. At this time, the charges are discharged from the liquid crystal capacitors Clc to the data lines D1 to Dm by the thin film transistors T.

Such a gate driving unit 200 is manufactured on the lower substrate of the display panel 100 as described above. Referring to FIG. 2, the gate driving unit 200 includes first to n-th stages 200-1 to 200-n respectively connected to the plurality of gate lines G1 to Gn. The first to n-th stages 200-1 to 200-n operate according to the second vertical synchronization start signal STVP or an output signal of the preceding stages 200-1 to 200-n-1. The first to n-th stages 200-1 to 200-n then, supply the gate turn-on signal or the gate turn-off signal to the plurality of gate lines G1 to Gn according to the gate clock signal CKV, the gate clock bar signal CKVB, and the control voltage Voff.

The first stage 200-1 operates according to the second vertical synchronization start signal STVP, the gate clock signal CKV, the gate clock bar signal CKVB and the control voltage Voff, and provides the gate turn-on signal to the first gate line G1. The second to n-th stages 200-2 to 200-n sequentially operate according to the output signal (i.e., the gate turn-on signal) of the preceding stages 200-1 to 200-n-1, the gate clock signal CKV, the gate clock bar signal CKVB and the control voltage Voff, and then, provide the gate turn-on signal to the second to n-th gate lines G2 to Gn.

The first to n-1-th stages 200-1 to 200-n-G1 are respectively reset by the output signal (i.e., the gate turn-on signal) of the succeeding stages, i.e., the second to n-th stages 200-2 to 200-n. According to an exemplary embodiment, the last stage, i.e., the n-th stage 200-n, is reset by an output of a dummy stage, which is located subsequent to the n-th stage 200-n. According to an exemplary embodiment, the n-th stage 200-n may be reset by a separate control signal.

In this exemplary embodiment, when the external supply voltage Vcc is applied, the gate clock generating unit 400 supplies the second vertical synchronization start signal STVP to the first stage 200-1 and provides the gate clock signal CKV and the gate clock bar signal CKVB to the first to n-th stages 200-1 to 200-n. In a state where the external supply voltage Vcc is being applied, the discharging unit 600 provides the control voltage Voff having the level of the first gate turn-off voltage Voffs to the first to n-th stages 200-1 to 200-n. Accordingly, the first to n-th stages 200-1 to 200-n sequentially provide the gate turn-on signal to the first to n-th gate lines G1 to Gn. In addition, the first to n-th stages 200-1 to 200-n provide the gate turn-off signal having the level of the control voltage Voff to the gate lines G1 to Gn to which the gate turn-on signal is not applied. That is, if the first stage 200-1 applies the gate turn-on signal to the first gate line G1, the second to n-th stages 200-2 to 200-n apply the gate turn-off signal to the second to n-th gate lines G2 to Gn. Accordingly, all the thin film transistors T connected to the first gate line G1 can be turned on, and the thin film transistors T connected to the second to n-th gate lines G2 to Gn can be turned off.

In this exemplary embodiment, when the external supply voltage Vcc is not applied, the gate clock generating unit 400 does not operate, and the gate clock signal CKV or the gate clock bar signal CKVB is not provided to the first to n-th stages 200-1 to 200-n. However, when the external supply voltage Vcc is not applied, the discharging unit 600 modifies the level of the control voltage Voff and supplies the modified voltage to the first to n-th stages 200-1 to 200-n, the control voltage Voff being the output of the discharging unit 600. In the current exemplary embodiment, the control voltage Voff has the same level as the gate turn-on voltage Von. Accordingly, the first to n-th stages 200-1 to 200-n provide the control voltage Voff having the modified level to the first to n-th gate lines G1 to Gn. That is, the voltage at the level of the gate turn-on voltage Von is applied to the first to n-th gate lines G1 to Gn. Accordingly, all the thin film transistors T connected to the first to n-th gate lines G1 to Gn are turned on.

The voltages used in the gate clock generating unit 400, the gate driving unit 200 and the discharging unit 600 are provided from the driving-voltage generating unit 500. The driving-voltage generating unit 500 generates various voltages using the external supply voltage Vcc and the driving voltage clock DCLK. When the external supply voltage Vcc is not applied, the driving-voltage generating unit 500 does not operate, and therefore, the voltages used in the gate clock generating unit 400, the gate driving unit 200 and the discharging unit 600 are not supplied.

Referring to FIG. 3, the driving-voltage generating unit 500 includes a reference-voltage generating unit 510, a gate turn-on voltage generating unit 520, and a gate turn-off voltage generating unit 530.

According to an exemplary embodiment, the driving-voltage generating unit 500 is an IC chip performing DC-DC conversion. Further, the aforementioned generating units 510, 520 and 530 may be integrated in the IC chip.

The reference-voltage generating unit 510 receives the external supply voltage Vcc and the driving voltage clock DCLK and generates a switching voltage PWM_SW and a reference voltage AVDD. The switching voltage PWM_SW include a pulse width modulation signal. That is, the switching voltage PWM_SW is a square wave pulse, and a duty ratio of the switching voltage is variably controlled. The reference voltage AVDD is a voltage obtained by rectifying the switching voltage PWM_SW. According to an exemplary embodiment, the reference-voltage generating unit 510 includes a pulse generating unit (not shown) which generates a pulse signal and a rectifying unit (not shown) which rectifies and outputs the pulse signal.

The gate turn-on voltage generating unit 520 pumps the switching voltage PWM_SW using the reference voltage AVDD as a reference voltage to generate the gate turn-on voltage Von. In the current exemplary embodiment, the level of the gate turn-on voltage Von varies according to the number of pumpings of the switching voltage PWM_SW. The gate turn-off voltage generating unit 530 pumps the switching voltage PWM_SW using a ground voltage as a reference voltage to generate the first gate turn-off voltage Voffs and the second gate turn-off voltage Voffe. In the current exemplary embodiment, the first gate turn-off voltage Voffs and the second gate turn-off voltage Voffe are generated by a different number of pumpings of the switching voltage PWM_SW. For example, the first gate turn-off voltage Voffs is generated by pumping the switching voltage PWM_SW once or twice, whereas the second gate turn-off voltage Voffe is generated by pumping the switching voltage PWM_SW at two or three times. The present invention is not limited hereto and may vary accordingly.

According to an exemplary embodiment, the gate turn-on voltage generating unit 520 and the gate turn-off voltage generating unit 530 includes a charge pumping circuit.

Referring to FIG. 4, the driving-voltage generating unit 500 is not limited to the aforementioned configurations but may further include a common-voltage generating unit 540 which generates a common voltage Vcom using the reference voltage AVDD and the switching voltage PWM_SW. The common voltage Vcom generated by the common-voltage generating unit 540 is provided to the display panel 100. The common-voltage generating unit 540 receives the reference voltage AVDD, and decreases or stabilizes the voltage through a resistor or regulator to generate the common voltage Vcom. In the current exemplary embodiment, the gate turn-off voltage generating unit 530 is divided into a first gate turn-off voltage generating unit 531 which generates the first gate turn-off voltage Voffs, and a second gate turn-off voltage generating unit 532 which generates the second gate turn-off voltage Voffe.

In FIG. 4, the voltages generated by the driving-voltage generating unit 500 are provided to the data driving unit 300, the gate clock generating unit 400, and the discharging unit 600, as described above.

Further, in the current exemplary embodiment, the discharging unit 600 receives the gate turn-on voltage Von and the first gate turn-off voltage Voffs and changes the level of the control voltage Voff depending on a state of the external supply voltage Vcc.

Referring to FIG. 5, the discharging unit 600 includes a first switching unit 610 and a second switching unit 620. The first switching unit 610 operates while the external supply voltage Vcc is supplied, and outputs the first gate turn-off voltage Voffs as the control voltage Voff. The second switching unit 620 operates while the external supply voltage Vcc is blocked, and outputs the gate turn-on voltage Von as the control voltage Voff, as shown in FIG. 5.

In the current exemplary embodiment, the discharging unit 600 further includes a short-circuit protection unit 640 which prevents short-circuiting between the input terminal of the gate turn-on voltage Von and the input terminal of the first gate turn-off voltage Voffs. The first and second switching units 610 and 620 are connected to an output terminal of the control voltage Voff. Accordingly, when the first and second switching units 610 and 620 are both opened, the voltage at a level of the gate turn-on voltage Von and the voltage at a level of the first gate turn-off voltage Voffs are simultaneously applied to the output terminal of the control voltage Voff. This will be described in detail below.

The discharging unit 600 uses the first gate turn-off voltage Voffs as the control voltage Voff during normal operation (i.e., when the supply voltage Vcc is applied). The discharging unit 600 changes the level of the control voltage Voff from the level of the first gate turn-off voltage Voffs to the level of the gate turn-on voltage Von only when the supply of the external supply voltage Vcc is blocked. The switching operation is performed by switching devices provided in the first and second switching units 610 and 620.

As described above, the first gate turn-off voltage Voffs and the gate turn-on voltage Von are generated by the driving-voltage generating unit 500 when the external supply voltage Vcc is applied, and not generated when the external supply voltage Vcc is not applied.

The first gate turn-off voltage Voffs and the gate turn-on voltage Von are generated through voltage (charges) pumping at the driving-voltage generating unit 500.

Thus, in this current exemplary embodiment, the short-circuit protection unit 640 is disposed at the input terminal of the gate turn-on voltage Von, and a voltage divider is used as the short-circuit protection unit 640 to apply voltage across the voltage divider, so that short-circuiting can be prevented and the current flow can be controlled.

Here, the short-circuit protection unit 640 is provided between the input terminal of the gate turn-on voltage Von and the second switching unit 620.

According to an exemplary embodiment, the discharging unit 600 further includes a charge storage unit 630 for storing charges corresponding to the gate turn-on voltage Von. The short-circuit protection unit 640 and the second switching unit 620 are connected in series between the input terminal of the gate turn-on voltage Von and the output terminal of the control voltage Voff, as shown in FIG. 5. The charge storage unit 630 is connected to a ground and a line which connects the short-circuit protection unit 640 and the second switching unit 620. The charge storage unit 630 receives the gate turn-on voltage Von from the short-circuit protection unit 640 connected to the input terminal of the gate turn-on voltage Von. The second switching unit 620 is turned off, so the gate turn-on voltage Von stored in the charge storage unit 630 cannot be applied to the output terminal of the control voltage Voff. Accordingly, when the external supply voltage Vcc is not applied, the gate turn-on voltage Von stored in the charge storage unit 630 can be output as the control voltage Voff by the second switching unit 620 and the first switching unit 610 is turned off.

A detailed circuit of the discharging unit 600 will now be described.

Referring to FIG. 6, the first switching unit 610 includes a first transistor TR1 having an emitter connected to the input terminal of the first gate turn-off voltage Voffs and a collector connected to the output terminal of the control voltage Voff, a first resistor R1 connected between a base of the first transistor TR1 and the ground, and a second resistor R2 connected between the collector of the first transistor TR1 and the ground.

As shown in FIG. 7, the short-circuit protection unit 640 includes a third resistor R3 connected to the input terminal of the gate turn-on voltage Von. The third resistor is located at an output terminal of the short-circuit protection unit 640. The charge storage unit 630 includes a first diode D1 connected to the output terminal of the short-circuit protection unit 640 (i.e., an input terminal of the charge storage unit 630) and an input terminal of the second switching unit 620 (i.e., an output terminal of the charge storage unit 630), a fourth resistor R4 connected between the output terminal of the short-circuit protection unit 640 and the ground, first and second capacitors C1 and C2 connected in series between the input terminal of the second switching unit 620 and the ground, a fifth resistor R5 connected in parallel with the second capacitor C2, third and fourth capacitors C3 and C4 connected in series between the input terminal of the second switching unit 620 and the ground, and a sixth resistor connected in parallel with the fourth capacitor C4. The second switching unit 620 includes a second transistor TR2 having an emitter connected to the output terminal of the charge storage unit 630 and a collector connected to the output terminal of the control voltage Voff, and a seventh resistor R7 connected between a base of the second transistor TR2 and the output terminal of the short-circuit protection unit 640.

In the current exemplary embodiment, the first transistor TR1 is an NPN type, and the second transistor TR2 is a PNP type. The third resistor R3 of the short-circuit protection unit 640 includes a resistance value in a range of approximately 0.1 to approximately 10 kΩ.

Thus, in this current exemplary embodiment, the third resistor R3 of a few kΩ is connected between the first diode D1 of the charge storage unit 630 and the input terminal of the gate turn-on voltage Von and used as the short-circuit protection unit 640. Accordingly, the gate turn-on voltage Von and the first gate turn-off voltage Voffs can be prevented from being simultaneously supplied to the output terminal of the control voltage Voff even though the first and second transistors TR1 and TR2 of the first and second switching units 610 and 620 are simultaneously turned on when the external supply voltage Vcc is initially applied.

If the display is turned on, the external supply voltage Vcc is applied to the display and the driving-voltage generating unit 500 begins to operate. When the external supply voltage Vcc is applied to the display, large driving current flows into the display panel 100, so that the level of the external supply voltage Vcc is lowered. As a result, the level of the output voltage of the driving-voltage generating unit 500 is also lowered. In this case, the gate turn-on voltage Von, which is the output of the driving-voltage generating unit 500, is applied to the base of the second transistor TR2 of the second switching unit 620. Accordingly, the voltage applied to the base of the second transistor TR2 also decreases. However, the voltage input to the emitter of the second transistor TR2 is less decreased due to the presence of the charge storage unit 630. Accordingly, the second transistor TR2 of the second switching unit 620 is turned on since a higher voltage is applied to the emitter as compared to the base. At this time, the applied external supply voltage Vcc causes the first transistor TR1 of the first switching unit 610 to be turned on.

According to an exemplary embodiment, the first and second transistors TRI and TR2 are simultaneously turned on when the display is turned on, or when the level of the gate turn-on voltage Von instantaneously varies while the display is being driven.

When the first and second transistors TR1 and TR2 are simultaneously turned on, a voltage between the gate turn-on voltage Von and the first gate turn-off voltage Voffs may be provided as the control voltage Voff. That is, the input terminal of the gate turn-on voltage Von and the input terminal of the first gate turn-off voltage Voffs may be short-circuited. However, in this current exemplary embodiment, the third resistor R3 is provided at a preceding stage of the second switching unit 620 as the short-circuit protection unit 640, thus, preventing the short-circuiting between the input terminal of the gate turn-on voltage Von and the input terminal of the first gate turn-off voltage Voffs when the first and second transistors TR1 and TR2 are simultaneously turned on. A limited current flows through the output terminal of the control voltage Voff, wherein the limited current has a value corresponding to a difference between the gate turn-on voltage Von and the first gate turn-off voltage Voffs divided by the resistance of the third resistor R3. Thus, the short-circuiting between the input terminal of the gate turn-on voltage Von and the input terminal of the first gate turn-off voltage Voffs can be prevented.

If the input terminals are short-circuited, current flowing through the output terminal of the control voltage Voff may increase rapidly (to approximately 1.5˜2 A). However, the third resistor R3 can prevent such a short-circuiting and reduce the current (to approximately 0.3˜0.6 A) flowing through the output terminal of the control voltage Voff.

In the aforementioned exemplary embodiment, the third resistor R3 is used as the short-circuit protection unit 640. However, the short-circuit protection unit 640 is not limited thereto but may be a switching device that is turned on and off depending on a current flowing at the gate turn-on voltage Von. When the current flowing at the gate turn-on voltage Von is higher than a target current, the switching device is turned off. In this way, short-circuiting between the input terminal of the gate turn-on voltage Von and the input terminal of the first gate turn-off voltage Voffs can be prevented. In addition, when the current flowing at the gate turn-on voltage Von is equal to the target current, the switching device is turned on. In this way, the gate turn-on voltage Von can be charged in the charge storage unit 630. In the current exemplary embodiment, the gate turn-on voltage Von generated by the driving-voltage generating unit 500 is applied to the discharging unit 600. However, the present invention is not limited thereto, but any voltage capable of turning on the thin film transistors T in the display panel 100 may be provided to the discharging unit 600 instead of the gate turn-on voltage Von. Further, in this exemplary embodiment, the discharging unit 600 is manufactured as a separate circuit. However, the present invention is not limited thereto, but the discharging unit 600 may be integrally manufactured with the driving-voltage generating unit 500. That is, the driving-voltage generating unit 500 may further include a circuit functioning as the discharging unit 600 of this exemplary embodiment. Alternatively, according to another exemplary embodiment, the discharging unit 600 is integrally manufactured with the gate driving unit 200. Thus, the gate driving unit 200 may be manufactured in the form of an IC chip, and a module functioning as the discharging unit 600 may be added in the IC chip.

In this exemplary embodiment, a liquid crystal display panel is used as the display panel 100. However, the present invention is not limited thereto, and various display panels capable of forcibly discharging accumulated charges from the display panels when the external supply voltage Vcc is not supplied may be used. For example, the display panel 100 may be a plasma display panel (PDP).

As described above, in the present invention, the short-circuit protecting unit 640 is connected to the input terminal of the gate turn-on voltage Von of the discharging unit 600 which outputs the gate turn-off voltage Voffs as the control voltage while the supply voltage is applied through the switch and outputs the gate turn-on voltage Von as the control voltage at a point when the supply voltage is turned off, thereby preventing short-circuiting between the input terminal of the gate turn-on voltage Von and the input terminal of the gate turn-off voltage Voffs through the output terminal of the control voltage.

According to the present invention, by preventing short-circuiting between the input terminal of the gate turn-on voltage Von and the input terminal of the gate turn-off voltage Voffs, sudden increase of the current flow into the output terminal of the control voltage can be prevented and charge flow into the output terminal of the control voltage can be limited.

While the present invention has been shown and described with reference to some exemplary embodiment thereof, it should be understood by those of ordinary skill in the art that various changes in form and details may be made therein without departing from the spirit and scope of the present invention as defined by the appending claims.

What is claimed is:

1. A display, comprising:
a display panel comprising a plurality of gate lines connected to a plurality of pixels;
a gate driving unit which sequentially provides a gate turn-on voltage to the plurality of gate lines and provides a control voltage to the plurality of gate lines to which the gate turn-on voltage is not applied; and
a discharging unit comprising a first input terminal receiving the gate turn-on voltage, a second input terminal receiving a first gate turn-off voltage, a output terminal outputting the control voltage and a short-circuit protection unit which prevents short-circuiting between the first input terminal and the second input terminal,
wherein the discharging unit provides the control voltage to the gate driving unit and a voltage level of the control voltage changes to any one level of a gate turn-on voltage and a first gate turn-off voltage response to a supply voltage.

2. The display as claimed in claim 1, wherein the discharging unit outputs the first gate turn-off voltage as the control voltage while the supply voltage is applied to the display and uses the gate turn-on voltage at a point when the supply voltage is not applied to the display.

3. The display as claimed in claim 1, wherein the discharging unit further comprises:
a first switching unit which outputs the first gate turn-off voltage as the control voltage while the supply voltage is applied;
a charge storage unit which stores the gate turn-on voltage; and
a second switching unit which outputs the stored gate turn-on voltage as the control voltage at a point when the supply voltage is not applied.

4. The display as claimed in claim 3, wherein the short-circuit protection unit is connected to the first input terminal and provides the gate turn-on voltage to the charge storage unit.

5. The display as claimed in claim 3, wherein the first switching unit comprises:
a first transistor comprising an emitter connected to the second input terminal and a collector connected to an output terminal;
a first resistor connected to a base of the first transistor and a ground; and
a second resistor connected to the collector of the first transistor and the ground.

6. The display as claimed in claim 5, wherein the short-circuit protection unit comprises a third resistor connected to the first input terminal and an output terminal.

7. The display as claimed in claim 6, wherein the charge storage unit comprises:
a first diode connected to the output terminal and an input terminal of the second switching unit;
a fourth resistor connected to the output terminal and a ground;
first and second capacitors connected in series between the input terminal of the second switching unit and the ground;
a fifth resistor connected in parallel with the second capacitor;
third and fourth capacitors connected in series between the input terminal of the second switching unit and the ground; and
a sixth resistor connected in parallel with the fourth capacitor.

8. The display as claimed in claim 7, wherein the second switching unit comprises:
a second transistor comprising an emitter connected to the input terminal of the second switching unit;
a collector connected to an output terminal; and
a seventh resistor connected to a base of the second transistor and the output terminal of the short-circuit protection unit.

9. The display as claimed in claim 5, wherein the short-circuit protection unit comprises a switching device which turns on and off depending on an amount of current flowing at the gate turn-on voltage.

10. The display as claimed in claim 1, wherein each of the plurality of pixels comprises a thin film transistor, wherein the gate turn-on voltage turns on the thin film transistor, and the first gate turn-off voltage turns off the thin film transistor.

11. The display as claimed in claim 1, further comprising:
a driving-voltage generating unit which generates the gate turn-on voltage, the first gate turn-off voltage and a second gate turn-off voltage according to the supply voltage; and
a gate clock generating unit which generates a gate clock signal, a gate clock bar signal and a second vertical synchronization start signal using the gate turn-on voltage, the second gate turn-off voltage and a first vertical synchronization start signal,
wherein the gate driving unit comprises a plurality of stages respectively connected to the plurality of gate lines, and
the plurality of stages sequentially provide the gate turn-on signal to the plurality of gate lines according to the gate clock signal, the gate clock bar signal and the second vertical synchronization start signal.

12. The display as claimed in claim 1, wherein the gate driving unit is formed at one side of the display panel.

13. The display as claimed in claim 1, wherein the gate driving unit is manufactured in the form of an IC chip to be connected to the plurality of gate lines of the display panel.

14. The display as claimed in claim 1, wherein the discharging unit is provided on a printed circuit board electrically connected to the display panel via a flexible printed circuit board or on the flexible printed circuit board.

15. A discharging device of a display which supplies a gate turn-off voltage to the display panel while a supply voltage is applied and which supplies a gate turn-on voltage to the display panel at a point when the supply voltage is not applied, the discharging device comprising a short-circuit protection unit which prevents short-circuiting between an input terminal of the gate turn-on voltage and an input terminal of a first gate turn-off voltage.

16. The discharging device as claimed in claim 15, further comprising:
a first switching unit which supplies the gate turn-off voltage to the display panel while the supply voltage is being applied to the display;
a charge storage unit which stores the gate turn-on voltage; and
a second switching unit which supplies the stored gate turn-on voltage to the display panel at the point when the supply voltage is not applied to the display.

17. The discharging device as claimed in claim 15, wherein the short-circuit protection unit is connected to the input terminal of the gate turn-on voltage and supplies the gate turn-on voltage to the charge storage unit.

18. The discharging device as claimed in claim 17, wherein the short-circuit protection unit comprises a resistor.

19. The discharging device as claimed in claim 17, wherein the short-circuit protection unit comprises a switching device which turns on and off depending on an amount of current flowing at the gate turn-on voltage.
